(19) United States
(12) Patent Application Publication
(10) Pub. No.: US 2022/0145120 A1
(43) Pub. Date: May 12, 2022

(54) AUTOMOTIVE COATINGS CONTAINING PHOTONIC SPHERES

(71) Applicant: BASF COATINGS GMBH, Münster (DE)

(72) Inventors: Zenon Paul CZORNIJ, Southfield, MI (US); Rupa Hiremath DARJI, Tarrytown, NY (US); Kurt F. WILLMING, Southfield, MI (US)

(21) Appl. No.: 17/438,400

(22) PCT Filed: Mar. 11, 2020
(86) PCT No.: PCT/US2020/022166

§ 371 Date: Sep. 10, 2021

Related U.S. Application Data
(60) Provisional application No. 62/817,208, filed on Mar. 12, 2019.

(51) Int. Cl. C09D 163/00; C08K 7/18; C09D 7/20; C09D 7/61

(52) U.S. Cl. CPC C09D 163/00; C08K 7/18; C08K 2201/005; C09D 7/61; C09D 7/20

(57) ABSTRACT

Disclosed in certain embodiments is a coating composition comprising (i) a solvent, (ii) a resinous binder and (iii) a structural colorant comprising spherical photonic structures and corresponding coatings, coated automotive parts and methods thereof.

### CROSS-REFERENCE TO RELATED APPLICATION(S)

This application claims the benefit of priority of U.S. Provisional Patent Application No. 62/817,208, filed on Mar. 12, 2019, the disclosure of which is hereby incorporated by reference herein in its entirety.

### TECHNICAL FIELD

Disclosed are automotive coatings that include a structural colorant in the form of photonic spheres as well as coating compositions and methods thereof.

### BACKGROUND

Traditional pigments and dyes exhibit color via light absorption and reflection, relying on chemical structure. Structural colorants exhibit color via light interference effects, relying on physical structure as opposed to chemical structure. Structural colorants are found in nature, for instance in bird feathers, butterfly wings and certain gemstones. Structural colorants are materials containing microscopically structured surfaces small enough to interfere with visible light and produce color.

Structural colorants can be manufactured to provide color in various goods such as paints and automotive coatings. For manufactured structural colorants, it is desired that the material exhibit high chromatic values, special photonic effects, dimensions allowing their use in particular applications, and chemical and thermal robustness. The robustness of the material is important in order to allow their in-process stability in paint systems and under various natural weathering conditions.

There exists a continued need in the art for automotive coatings that include structural colorant that provides a diverse range of robust colors.

### OBJECTS AND SUMMARY OF THE INVENTION

It is an object of certain embodiments of the present invention to provide an automotive coating composition that includes a structural colorant comprising photonic spheres.

It is another object of certain embodiments of the present invention to provide a method of preparing an automotive coating composition that includes a structural colorant comprising photonic spheres.

It is a further object of certain embodiments of the present invention to provide an automotive coating that includes a structural colorant comprising photonic spheres.

It is a further object of certain embodiments of the present invention to provide a manufactured automotive article that has a substrate and a coating that includes a structural colorant comprising photonic spheres.

One or more of the above objects and others can be achieved by virtue of the present invention which in certain embodiments is directed to a coating composition comprising (i) a solvent, (ii) a resinous binder and (iii) a structural colorant comprising photonic spheres. In certain embodiments, the coating composition provides a coating that exhibits an L* value from 15 degree angle to 110 degree angle from specular reflection that does not change by more than about 50%, by more than about 35% or by more than about 25%.

In certain embodiments, the coating composition provides a coating that exhibits an L* value that increases from 15 degree angle to 110 degree angle from specular reflection.

In certain embodiments, the coating composition provides a coating that exhibits an L* value from 15 degree angle to 110 degree angle from specular reflection that changes more than about 3 units, more than about 5 units or more than about 10 units.

In certain embodiments, the coating composition provides a coating that exhibits an L* value from 15 degree angle to 110 degree angle from specular reflection that changes less than about 25 units, less than about 15 units or less than about 10 units.

In certain embodiments, the coating composition provides a coating that exhibits a C* value from 15 degree angle to 110 degree angle from specular reflection that does not change by more than about 50%, by more than about 35% or by more than about 25%.

In certain embodiments, the coating composition provides a coating that exhibits a C* value that decreases from 15 degree angle to 110 degree angle from specular reflection.

In certain embodiments, the coating composition provides a coating that exhibits a C* value from 15 degree angle to 110 degree angle from specular reflection that changes more than about 3 units, more than about 5 units or more than about 10 units.

In certain embodiments, the coating composition provides a coating that exhibits a C* value from 15 degree angle to 110 degree angle from specular reflection that changes less than about 25 units, less than about 15 units or less than about 10 units.

In certain embodiments, the coating composition provides a coating that exhibits an h value from 15 degree angle to 110 degree angle from specular reflection that does not change by more than about 75%, by more than about 50%, by more than about 25% or by more than about 10%.

In certain embodiments, the coating composition provides a coating that exhibits an h value that decreases from 15 degree angle to 110 degree angle from specular reflection.

In certain embodiments, the coating composition provides a coating that exhibits an h value from 15 degree angle to 110 degree angle from specular reflection that changes more than about 25 units, more than about 50 units or more than about 100 units.

In certain embodiments, the coating composition provides a coating that exhibits an h value from 15 degree angle to 110 degree angle from specular reflection that changes less than about 200 units, less than about 150 units or less than about 100 units.

In certain embodiments, the coating composition provides a coating that exhibits an a* value from 15 degree angle to 110 degree angle from specular reflection that does not change by more than about 10 units, by more than about 5 units or more than about 2 units.

In certain embodiments, the coating composition provides a coating that exhibits a b* value from 15 degree angle to 110 degree angle from specular reflection that does not change by more than about 25 units, by more than about 15 units or more than about 10 units.

Other embodiments are directed to a coating comprising a resinous binder and a structural colorant comprising photonic spheres. In certain embodiments, the coating exhibits an L* value from 15 degree angle to 110 degree angle from specular reflection that does not change by more than about 50%, by more than about 35% or by more than about 25%.

In certain embodiments, the coating exhibits an L* value that increases from 15 degree angle to 110 degree angle from specular reflection.

In certain embodiments, the coating exhibits an L* value from 15 degree angle to 110 degree angle from specular reflection that changes more than about 3 units, more than about 5 units or more than about 10 units.

In certain embodiments, the coating exhibits an L* value from 15 degree angle to 110 degree angle from specular reflection that changes less than about 25 units, less than about 15 units or less than about 10 units.

In certain embodiments, the coating exhibits a C* value that decreases from 15 degree angle to 110 degree angle from specular reflection.

In certain embodiments, the coating exhibits a C* value from 15 degree angle to 110 degree angle from specular reflection that changes more than about 3 units, more than about 5 units or more than about 10 units.

In certain embodiments, the coating exhibits a C* value from 15 degree angle to 110 degree angle from specular reflection that changes less than about 25 units, less than about 15 units or less than about 10 units.

In certain embodiments, the coating exhibits an h value that decreases from 15 degree angle to 110 degree angle from specular reflection.

In certain embodiments, the coating exhibits an h value from 15 degree angle to 110 degree angle from specular reflection that changes more than about 25 units, more than about 50 units or more than about 100 units.

In certain embodiments, the coating exhibits an h value from 15 degree angle to 110 degree angle from specular reflection that changes less than about 200 units, less than about 150 units or less than about 100 units.

Further embodiments are directed to automotive parts comprising the coatings disclosed herein and methods thereof.

### BRIEF DESCRIPTION OF DRAWINGS

The disclosure described herein is illustrated by way of example and not by way of limitation in the accompanying figures.

FIG. 1A shows CIEL*a*b* values for a control coating.

FIG. 1B depicts remission curves for a control coating.

FIG. 2A shows CIEL*a*b* values for an inventive coating.

FIG. 2B depicts remission curves for an inventive coating.

### DETAILED DESCRIPTION

In certain embodiments, the invention is directed to a coating composition comprising (i) a solvent, (ii) a resinous binder and (iii) a structural colorant comprising photonic spheres

Certain embodiments are directed to coatings derived from the coating compositions disclosed herein.

Certain embodiments are directed to a coating comprising a colorant layer comprising a (i) a resinous binder and (ii) a structural colorant comprising photonic spheres.

In certain embodiments, the coating further comprises a ground coat, wherein the colorant layer is layered over the ground coat. The ground coat can be, e.g., black.

Certain embodiments further comprise a clear coat layer, wherein the clear coat is layered over the colorant layer.

Certain embodiments further comprise one or more additional layers (i) between the ground layer and the colorant layer, (ii) between the colorant layer and the clear coat layer, (iii) over the clear coat layer, (iv) under the ground layer, or a combination thereof. The structural colorant can be included in one or more of the ground, layer, the colorant layer, the clear coat layer or any of the additional layers.

In certain embodiments disclosed herein, the coating exhibits, e.g., an L* value from 15 degree angle to 110 degree angle from specular reflection that does not change by more than about 50%, by more than about 35% or by more than about 25%.

In other embodiments, the coating exhibits, e.g., an L* value that increases from 15 degree angle to 110 degree angle from specular reflection.

In further embodiments, the coating exhibits, e.g., an L* value from 15 degree angle to 110 degree angle from specular reflection that changes more than about 3 units, more than about 5 units or more than about 10 units.

In other embodiments, the coating exhibits, e.g., an L* value from 15 degree angle to 110 degree angle from specular reflection that changes less than about 25 units, less than about 15 units or less than about 10 units.

In further embodiments, the coating exhibits, e.g., a C* value from 15 degree angle to 110 degree angle from specular reflection that does not change by more than about 50%, by more than about 35% or by more than about 25%.

In other embodiments, the coating exhibits, e.g., a C* value that decreases from 15 degree angle to 110 degree angle from specular reflection.

In further embodiments, the coating exhibits, e.g., a C* value from 15 degree angle to 110 degree angle from specular reflection that changes more than about 3 units, more than about 5 units or more than about 10 units.

In other embodiments the coating exhibits, e.g., a C* value from 15 degree angle to 110 degree angle from specular reflection that changes less than about 25 units, less than about 15 units or less than about 10 units.

In further embodiments, the coating exhibits, e.g., an h value from 15 degree angle to 110 degree angle from specular reflection that does not change by more than about 75%, by more than about 50%, by more than about 25% or by more than about 10%.

In other embodiments, the coating exhibits, e.g., an h value that decreases from 15 degree angle to 110 degree angle from specular reflection.

In further embodiments, the coating exhibits, e.g., an h value from 15 degree angle to 110 degree angle from specular reflection that changes more than about 25 units, more than about 50 units or more than about 100 units.

In other embodiments, the coating exhibits, e.g., an h value from 15 degree angle to 110 degree angle from specular reflection that changes less than about 200 units, less than about 150 units or less than about 100 units.

In further embodiments, the coating exhibits, e.g., an a* value from 15 degree angle to 110 degree angle from specular reflection that does not change by more than about 10 units, by more than about 5 units or more than about 2 units.

In other embodiments, the coating exhibits, e.g., a b* value from 15 degree angle to 110 degree angle from specular reflection that does not change by more than about 25 units, by more than about 15 units or more than about 10 units.

In any embodiments disclosed herein, the photonic spheres can be, e.g., direct photonic spheres or inverse photonic spheres.

In any embodiments disclosed herein, the structural colorant can exhibit, e.g., angle-dependent color or angle independent color.

In any embodiments disclosed herein, the ratio of structural colorant to resinous binder is, e.g., about 1:100 to about 50:100; about 5:100 to about 25:100; about 10:100 to about 20:100 or about 15:100.

In any embodiments disclosed herein, structural colorant can comprise a metal oxide.

The metal oxide can be, e.g., selected from is selected from the group consisting of silica, titania, alumina, zirconia, ceria, iron oxides, zinc oxide, indium oxide, tin oxide, chromium oxide and combinations thereof.

In certain embodiments, the coating composition can be, e.g., selected from silica, titania and combinations thereof.

In certain embodiments, the photonic spheres can have, e.g., an average diameter of from about 1 μm to about 75 μm.

In certain embodiments, the photonic spheres can have, e.g., an average pore diameter of from about 50 nm to about 800 nm.

In certain embodiments, the photonic spheres can have, e.g., an average porosity of from about 0.45 to about 0.65.

In certain embodiments, the structural colorant is de-agglomerated, e.g., by sonification.

In certain embodiments, at least a portion of the external surface of the structural colorant comprises silane functional groups.

In certain embodiments, the structural colorant comprises transition metal ions.

In certain embodiments, the structural colorant comprises an organic material such as carbon black.

Certain embodiments have a Zeta Potential (mV) of from about 5 to about 20; from about 8 to about 18; or about 10 to about 15.

Certain embodiments have an Intensity of from about 0 to about −100; from about −10 to about −50; about −15 to about −45; or about −40.

Certain embodiments are directed to an article of manufacture comprising a substrate and a coating as disclosed herein. The substrate can be, e.g., an automotive part such as an external panel or an interior part.

Certain embodiments are directed to a method of preparing a coating composition comprising mixing a solvent, a resinous binder and a structural colorant comprising photonic spheres to obtain the coating compositions as disclosed.

In certain embodiments, the method comprises mixing the solvent and the structural colorant and thereafter adding the resinous binder.

In certain embodiments, the method further comprises de-agglomerating the structural colorant, e.g., prior to adding the resinous binder.

In certain embodiments, the de-agglomeration is by sonification.

Certain embodiments are directed to a method of coating a substrate comprising layering a coating composition as disclosed herein onto a substrate.

In certain embodiments, the method comprises selecting the dimensions of the structural colorant to achieve a pre-determined color standard. In certain embodiments, the standard has been previously attained by the structural colorant. In other embodiments, the standard is based on a color achieved by a chemical colorant. In further embodiments, the dimensions are one or more of diameter, pore diameter and porosity.

In certain embodiments, the standard color has a wavelength of 380-450 nm, 450-485 nm, 485-500 nm, 500-565 nm, 565-590 nm, 590-625 nm or 625-704 nm. In other embodiments, the color of the layered substrate is the same or substantially the same as the standard based on spectrophotometry measurement.

### Water Base Coat

The coating compositions can be formed, e.g., by combining the structural colorants with water, and the at least one water-miscible film-forming binder to form an aqueous topcoat coating composition.

The at least one water-miscible film-forming binder may be dissolved or dispersed in an aqueous medium. Nonlimiting examples of suitable water-miscible film-forming binders may include polyurethane resins, acrylated polyurethane resins, poly(meth)acrylate polymers (acrylic polymers), polyester resins, acrylated polyester resins, polyether resins and alkyd resins. The aqueous topcoat coating composition may also include a binder system including more than one water-miscible film-forming binder.

The at least one water-miscible film-forming binder may be physically dried and/or chemically crosslinked, for example by polymerization, polycondensation, and/or polyaddition reactions. Chemically cross-linkable water-miscible film-forming binders may contain corresponding cross-linkable functional groups. Suitable functional groups may include, for example, hydroxyl groups, carbamate groups, isocyanate groups, acetoacetyl groups, unsaturated groups, for example, (meth)acryloyl groups, epoxide groups, carboxyl groups, and amino groups. The at least one water-miscible film-forming binder may be paired with or include a crosslinking agent. The crosslinking agent may include a complementarily-reactive functional group that may provide crosslinking during curing. For example, hydroxyl group-containing polymers and aminoplast (e.g., melamine) crosslinking agents may be used with chemically crosslinkable water-miscible film-forming binders.

Embodiments including aminoplast crosslinking agents may further include a strong acid catalyst to enhance curing of the aqueous topcoat coating composition. Such catalysts may include, for example, para-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts may also be blocked, e.g., with an amine.

The at least one water-miscible film-forming binder may include ionic and/or non-ionic groups such as carboxyl groups and polyethylene oxide segments. Suitable neutralizing agents for the carboxyl groups are basic compounds, such as tertiary amines, for example, triethylamine, dimethylethanolamine, and diethylethanolamine. Alternatively or additionally, the aqueous topcoat coating composition may also include one or more external emulsifiers. The external emulsifier(s) may disperse the water-miscible film-forming binder within the aqueous topcoat coating composition.

In one non-limiting example, the water-miscible film-forming binder is an aqueous polyurethane dispersion. The aqueous polyurethane dispersion may be prepared by emulsifying hydrophobic polyurethanes in water with the aid of one or more external emulsifiers. The aqueous polyurethane dispersion may also be prepared to be self-dispersible by incorporating hydrophilic groups. One technique for imparting water-miscibility or -dispersibility may include converting carboxylate groups into anionic groups using an amine to form an anionic, polyurethane dispersion. Another technique for imparting water-miscibility may include first reacting tertiary amino alcohols with prepolymers which contain free isocyanate functionality, and then neutralizing the reaction product with an acid to form a cationic polyurethane dispersion. A further technique may include modifying prepolymers having free isocyanate functions with water-soluble long-chain polyethers to form a nonionic polyurethane dispersion.

The aqueous topcoat coating composition may alternatively include a hybrid polyurethane-polyacrylate dispersion as the water-miscible film-forming binder. The hybrid polyurethane-polyacrylate dispersion may be prepared by emulsion-polymerizing a vinylpolymer, i.e., a polyacrylate, in an aqueous polyurethane dispersion. Alternatively, the hybrid polyurethane-polyacrylate dispersion may be prepared as a secondary dispersion.

The aqueous topcoat coating composition may include the photonic spheres in an amount of from about 0.01 part by weight to about 60 parts by weight, e.g., from about 1.0 part by weight to about 20 parts by weight, based on 100 parts by weight of the water-miscible film-forming binder. That is, blending may include adding to water from about 30 parts by weight photonic spheres to about 50 parts by weight photonic spheres based on 100 parts by weight of the at least one water-miscible film-forming binder.

The aqueous topcoat coating composition may further include a rheology control agent and/or film-forming agent such as a colloidal layered silicate. For example, the colloidal layered silicate may provide the aqueous topcoat coating composition with stability and adjust a thixotropic shear-sensitive viscosity of the aqueous topcoat coating composition. The colloidal layered silicate may be synthetically manufactured from an inorganic mineral and may have a colloidal, gel, or sol form. A suitable colloidal layered silicate is commercially available under the trade name Laponite® from the Byk-Chemie GmbH of Wesel, Germany. Therefore, the method may further include blending the colloidal layered silicate, the passivated pigment slurry, water, and the at least one water-miscible film-forming binder to form the aqueous topcoat coating composition.

The aqueous topcoat coating composition may also include other pigments and fillers. Nonlimiting examples of other pigments and fillers may include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium, ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, nanoparticles based on silicon dioxide, and aluminum oxide or zirconium oxide. The additional pigments can also include one or more flake-like pigments such as aluminum flakes or mica-based flakes.

The pigments may be dispersed in a resin or polymer or may be present in a pigment system which includes a pigment dispersant, such as the water-miscible film-forming binder resins of the kind already described. The pigment and dispersing resin, polymer, or dispersant may be brought into contact under a shear sufficient to break any agglomerated pigment down to primary pigment particles and to wet a surface of the pigment particles with the dispersing resin, polymer, or dispersant. The breaking of the agglomerates and wetting of the primary pigment particles may provide pigment stability and robust color.

The pigments and fillers may be present in the aqueous topcoat coating composition in an amount of less than or equal to about 60 parts by weight based on 100 parts by weight of the aqueous topcoat coating composition. For example, the pigments and fillers may be present in the aqueous topcoat coating composition in an amount of from about 0.5 parts by weight to 50 parts by weight, or from about 1 part by weight to about 30 parts by weight, or from about 2 parts by weight to about 20 parts by weight, or from about 2.5 parts by weight to about 10 parts by weight, based on 100 parts by weight of the aqueous topcoat coating composition. The amount of pigments and fillers present in the aqueous topcoat coating composition may be selected according to a make-up or nature of the pigment, on a depth of desired color of the cured film formed from the aqueous topcoat coating composition, on an intensity of a metallic and/or pearlescent effect of the cured film, and/or on a dispersibility of the pigment.

The aqueous topcoat coating composition may also include additive components such as, but not limited to, surfactants, stabilizers, dispersing agents, adhesion promoters, ultraviolet light absorbers, hindered amine light stabilizers, benzotriazoles or oxalanilides, free-radical scavengers, slip additives, defoamers, reactive diluents, wetting agents such as siloxanes, fluorine compounds, carboxylic monoesters, phosphoric esters, polyacrylic acids and their copolymers, for example polybutyl acrylate and polyurethanes, adhesion promoters such as tricyclodecanedimethanol, flow control agents, film-forming assistants such as cellulose derivatives, and rheology control additives such as inorganic phyllosilicates such as aluminum-magnesium silicates, sodium-magnesium, and sodium-magnesium-fluorine-lithium phyllosilicates of the montmorillonite type. The aqueous topcoat coating composition 14 may include one or a combination of such additives.

The aqueous topcoat coating composition may be suitable for coating automotive components and substrates and may be suitable for original finish and refinish automotive applications. Further, the aqueous topcoat coating composition may be characterized as a monocoat coating composition, and may be structured to be applied to the substrate as a single, uniformly-pigmented layer. Alternatively, the aqueous topcoat coating composition may be characterized as a basecoat/clearcoat coating composition, and may be structured to be applied to the substrate as two distinct layers, i.e., a lower, highly pigmented layer or basecoat, and an upper layer or clearcoat having little or no pigmentation. Basecoat/clearcoat coating compositions may impart a comparatively high level of gloss and depth of color.

### Forming the Aqueous Topcoat Coating System

The method of forming the aqueous topcoat coating system includes combining, reacting, and blending. The method further includes applying a film formed from the aqueous topcoat coating composition to the substrate. Applying may include, for example, spray coating, dip coating, roll coating, curtain coating, knife coating, spreading, pouring, dipping, impregnating, trickling, rolling, and combinations thereof. For automotive applications in which the substrate is, for example, a body panel, applying may include spray coating the aqueous topcoat coating composition onto the substrate. Nonlimiting example of suitable spray coating may include compressed-air spraying, airless spraying, high-speed rotation, electrostatic spray application, hot-air spraying, and combinations thereof. During applying, the substrate may be at rest, and application equipment configured for applying the aqueous topcoat coating composition to the substrate may be moved. Alternatively the substrate, e.g., a coil, may be moved, and the application equipment may be at rest relative to the substrate.

Nonlimiting examples of suitable substrates include metal substrates such as bare steel, phosphated steel, galvanized steel, or aluminum; and non-metallic substrates, such as plastics and composites. The substrate 44 may also include a layer formed from another coating composition, such as a layer formed from an electrodeposited primer coating composition, primer surfacer composition, and/or basecoat coating composition, whether cured or uncured.

For example, the substrate may be pretreated to include a layer formed from an electrodeposition (electrocoat) primer coating composition. The electrodeposition primer coating composition may be any electrodeposition primer coating composition useful for automotive vehicle coating operations. The electrodeposition primer coating composition may have a dry film thickness of from about 10 μm to about 35 μm and may be curable by baking at a temperature of from about 135° C. to about 190° C. for a duration of from about 15 minutes to about 60 minutes. Nonlimiting examples of electrodeposition primer coating compositions are commercially available under the trade name CathoGuard® from BASF Corporation of Florham Park, N.J.

Such electrodeposition primer coating compositions may include an aqueous dispersion or emulsion including a principal film-forming epoxy resin having ionic stabilization, e.g., salted amine groups, in water or a mixture of water and an organic cosolvent. The principal film-forming resin may be emulsified with a crosslinking agent that is reactive with functional groups of the principal film-forming resin under certain conditions, such as when heated, so as to cure a layer formed from the electrodeposition primer coating composition. Suitable examples of crosslinking agents, include, without limitation, blocked polyisocyanates. The electrodeposition primer coating compositions may further include one or more pigments, catalysts, plasticizers, coalescing aids, antifoaming aids, flow control agents, wetting agents, surfactants, ultraviolet light absorbers, hindered amine light stabilizer compounds, antioxidants, and other additives.

The method also includes curing the film to form the aqueous topcoat coating composition. Curing may include, for example, drying the aqueous topcoat coating composition so that at least some of any solvent and/or water is stripped from the film during an evaporation phase. Drying may include heating the film at a temperature of from about room temperature to about 80° C. Subsequently, the film may be baked, for example, under conditions employed for automotive original equipment manufacturer finishing, such as at temperatures from about 30° C. to about 200° C., or from about 70° C. to about 180° C., or from about 90° C. to about 160° C., for a duration of from about 20 minutes to about 10 hours, e.g., about 20 minutes to about 30 minutes for comparatively lower baking temperatures and from about 1 hour to about 10 hours for comparatively higher baking temperatures. In one example, the film may be cured at a temperature of from about 90° C. to about 160° C. for a duration of about 1 hour.

In addition, curing may not occur immediately after applying. Rather, curing may include allowing the film to rest or “flash”. That is, the film may be cured after a certain rest time or “flash” period. The rest time allows the aqueous topcoat coating composition to, for example, level and devolatilize such that any volatile constituents such as solvents may evaporate. Such a rest time may be assisted or shortened by the exposing the film to elevated temperatures or reduced humidity. Curing of the aqueous topcoat coating composition may include heating the film in a forced-air oven or irradiating the film with infrared lamps.

The resulting cured film may have a thickness of from about 5 μm to about 75 μm, e.g., about 30 μm to about 65 μm, depending, for example, upon a desired color or continuity of the cured film. Further, the cured film formed from the aqueous topcoat coating composition 14 may exhibit a metallic and/or pearlescent appearance.

Therefore, the aqueous topcoat coating system may include the substrate and the cured film formed from the aqueous topcoat coating composition and disposed on the substrate. Therefore, the method may also include, after curing, exposing the cured film to light without photo-degrading the cured film. That is, the first layer and the second layer of the passivated pigment slurry may provide the cured film formed from the aqueous topcoat coating composition with excellent photo-degradation protection upon exposure to wavelengths from ultraviolet light, visible light, and/or infrared radiation.

As such, the photonic sphere slurry or dispersion may be used in coating compositions for original finish and refinish automotive coating compositions, such as multicoat coating systems comprising at least one basecoat and at least one clearcoat disposed on the at least, in which the basecoat has been produced using the photonic sphere slurry.

Nonlimiting examples of suitable clearcoat coating compositions may include poly(meth)acrylate polymers, polyvinyl polymers, and polyurethanes. For example, the clearcoat composition may include a carbamate- and/or hydroxyl-functional poly(meth)acrylate polymer. For embodiments including a polymer having hydroxyl and/or carbamate functional groups, the crosslinking agent may be an aminoplast resin.

### Solvent Base Coat

In certain embodiments, the coating compositions may include one or more organic solvents. Nonlimiting examples of suitable solvents include aromatic hydrocarbons, ketones, esters, glycol ethers, and esters of glycol ethers. Specific examples include, without limitation, methyl ethyl ketone, methyl isobutyl ketone, m-amyl acetate, ethylene glycol butyl ether and ethylene glycol monobutyl ether acetate, propylene glycol monomethyl ether and propylene glycol monomethyl ether acetate, xylene, ethanol, propanol, isopropanol, n-butanol, isobutanol, tert-butanol, N-methyl pyrrolidone, N-ethyl pyrrolidone, Aromatic 100, Aromatic 150, naphtha, mineral spirits, butyl glycol, and so on.

The coating composition may optionally include further rheology control agents, including high molecular weight mixed cellulose esters, such as CAB-381-0.1, CAB-381-20. CAB-531-1, CAB-551-0.01, and CAB-171-155 (available from Eastman Chemical Company, Kingsport, Tenn.), which may be included in amounts of up to about 5 wt. %, or from about 0.1 to about 5 wt. %, or from about 1.5 to about 4.5 wt. %, based on total binder weight. Further examples include microgel rheology control agents such as crosslinked acrylic polymeric microparticles, which may be included in amounts of up to about 5 wt. % of total binder weight; wax rheology control agents such as polyethylene waxes including acrylic acid-modified polyethylene wax (e.g., Honeywell A-C® Performance Additives), poly(ethylene-vinyl acetate) copolymers, and oxidized polyethylenes, which may be included in amounts of up to about 2 wt. % on total binder weight; and fumed silicas, which may be included in amounts of up to about 10 wt. % on total binder weight or from about 3 to about 12 wt. % on total binder weight.

Additional agents, for example hindered amine light stabilizers, ultraviolet light absorbers, anti-oxidants, surfactants, stabilizers, wetting agents, adhesion promoters, etc. may be incorporated into the coating composition. Such additives are well-known and may be included in amounts typically used for coating compositions.

Nonlimiting examples of special effect pigments that may be utilized in basecoat and monocoat topcoat coating compositions include metallic, pearlescent, and color-variable effect flake pigments. Metallic (including pealescent, and color-variable) topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments, coated aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance (degree of reflectance or color) when viewed at different angles. Metal flakes may be cornflake type, lenticular, or circulation-resistant; micas may be natural, synthetic, or aluminum-oxide type. Flake pigments do not agglomerate and are not ground under high shear because high shear would break or bend the flakes or their crystalline morphology, diminishing or destroying the gonioapparent effects. The flake pigments are satisfactorily dispersed in a binder component by stirring under low shear. The flake pigment or pigments may be included in the high solids coating composition in an amount of about 0.01 wt. % to about 0.3 wt. % or about 0.1 wt. % to about 0.2 wt. %, in each case based on total binder weight.

Nonlimiting examples of commercial flake pigments include PALIOCROME® pigments, available from BASF Corporation.

Nonlimiting examples of other suitable pigments and fillers that may be utilized in basecoat and monocoat topcoat coating compositions include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and so on. The pigment or pigments are preferably dispersed in a resin or polymer or with a pigment dispersant, such as binder resins. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development. Pigments and fillers may be utilized in amounts typically of up to about 40% by weight, based on total weight of the coating composition.

In certain embodiments, the disclosed basecoats may have about 40 wt. % to about 55 wt. %, nonvolatile content, and typically may have about 45 wt. % to about 50 wt. % nonvolatile content, as determined by ASTM Test Method D2369, in which the test sample is heated at 110° C. (230° F.) for 60 minutes.

In certain embodiments, a substrate may be coated by applying a primer layer, optionally curing the primer layer; then applying a basecoat layer and a clearcoat layer, typically wet-on-wet, and curing the applied layers and optionally curing the primer layer along with the basecoat and clearcoat layers if the primer layer is not already cured, or then applying a monocoat topcoat layer and curing the monocoat topcoat layer, again optionally curing the primer layer along with the basecoat and clearcoat layers if the primer layer is not already cured. The cure temperature and time may vary depending upon the particular binder components selected, but typical industrial and automotive thermoset compositions prepared as we have described may be cured at a temperature of from about 105° C. to about 175° C., and the length of cure is usually about 15 minutes to about 60 minutes.

The coating composition can be coated on a substrate by spray coating. Electrostatic spraying is a preferred method. The coating composition can be applied in one or more passes to provide a film thickness after cure of a desired thickness, typically from about 10 to about 40 microns for primer and basecoat layers and from about 20 to about 100 microns for clearcoat and monocoat topcoat layers.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

The substrate may be first primed with an electrodeposition (electrocoat) primer. The electrodeposition composition can be any electrodeposition composition used in automotive vehicle coating operations. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The electrodeposition coating composition is preferably applied to a dry film thickness of 10 to 35 micron. After application, the coated vehicle body is removed from the bath and rinsed with deionized water. The coating may be cured under appropriate conditions, for example by baking at from about 275° F. to about 375° F. (about 135° C. to about 190° C.) for between about 15 and about 60 minutes.

### Alternative Embodiments

In certain embodiments, the photonic spheres utilized in the present invention comprise a metal oxide and an organic material. In certain embodiments, the organic material is present in an amount of from about 0.1% to about 50% w/w of the spheres. In certain embodiments, the spheres comprise from about 0.5% to about 25% of an organic material; from about 1% to about 10% of an organic material or from about 2% to about 8% of an organic material.

In certain embodiments, the organic material is within the pores of the spheres, on the surface of the spheres or a combination thereof.

In certain embodiments, the organic material is derived from decomposition (e.g., by combustion) of a precursor such as a saccharide.

In certain embodiments, the organic material is carbon black.

In certain embodiments, the photonic spheres utilized in the present invention comprises a metal oxide and a transition metal. In certain embodiments, the molar ratio of transition metal to metal oxide being less than about 2:1.

In certain embodiments, the photonic spheres have a molar ratio of transition metal to metal oxide from about 1:100 to about 1:1; about 1:50 to about 1:2 or about 1:5 to about 1:10.

In certain embodiments, the transition metal is selected from one or more of a Group 3 to 12 transition metal of the periodic table; a Group 4 to 11 transition metal on the periodic table; or a Group 8 to 10 transition metal on the periodic table. In one embodiment, the transition metal is cobalt.

In certain embodiments, the photonic spheres utilized in the present invention comprise metal oxide particles and silane functional groups on at least a portion of the external surface of the metal oxide particles.

In certain embodiments the silane functional groups are epoxy silanes, amino silanes, alkyl silanes, alkylhalosilanes or a combination thereof.

In certain embodiments the silyl functional groups are derived from reacting the porous metal oxide microspheres with a silane coupling agent.

In certain embodiments, the silane coupling agent comprises an organo functional group and a hydrolysable functional group bonded directly or indirectly to silicone.

In certain embodiments, the hydrolysable functional group is an alkoxy group.

In certain embodiments, the silyl functional groups are aminoethyl trimethoxy silanes, aminopropyl trimethoxysilanes, glycidoxypropyl trimethoxy silanes or a combination thereof. Certain embodiments can further comprise an acrylic functional resin.

In certain embodiments, the alkylhalosilane is an alkylchlorosilane. In other embodiments, the silane functional groups are decyltrichlorosilanes, perfluorooctyl-trichlorosilanes or a combination thereof.

In other embodiments, the silyl functional groups prevent or substantially prevent the infiltration of the liquid medium into pores of the structural colorants.

In certain embodiments, the reflective spectra of the silane functionalized spheres after storage for 24 hours at room temperature, standard atmosphere and relative humidity has a wavelength within 10% of the liquid coating composition prior to storage.

In certain embodiments, the reflective spectra of the silane functionalized spheres after storage for 2 days, 5 days, 7 days, 14 days or 28 days at room temperature, standard atmosphere and relative humidity has a wavelength within 8%, 5%, 4% or 2% of the liquid coating composition prior to storage.

Certain embodiments exhibit a wavelength range selected from the group consisting of 380 to 450 nm, 451-495 nm, 496-570 nm, 571 to 590 nm, 591, 620 nm and 621 to 750 nm.

In certain embodiments, the structural colorant photonic spheres can have, e.g., one or more of an average diameter of from about 0.5 μm to about 100 μm, an average porosity of from about 0.10 to about 0.80 and an average pore diameter of from about 50 nm to about 999 nm. In alternative embodiments, the particles can have, e.g., one or more of an average diameter of from about 1 μm to about 75 μm, an average porosity of from about 0.45 to about 0.65 and an average pore diameter of from about 50 nm to about 800 nm.

In certain embodiments, the structural colorant photonic spheres have an average diameter, e.g., of from about 1 μm to about 75 μm, from about 2 μm to about 70 μm, from about 3 μm to about 65 μm, from about 4 μm to about 60 μm, from about 5 μm to about 55 μm or from about 5 μm to about 50 μm; for example from any of about 5 μm, about 6 μm, about 7 μm, about 8 μm, about 9 μm, about 10 μm, about 11 μm, about 12 μm, about 13 μm, about 14 μm or about 15 μm to any of about 16 μm, about 17 μm, about 18 μm, about 19 μm, about 20 μm, about 21 μm, about 22 μm, about 23 μm, about 24 μm or about 25 μm. Alternative embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm.

In other embodiments, the structural colorant photonic spheres have an average porosity, e.g., of from any of about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48 about 0.50, about 0.52, about 0.54, about 0.56, about 0.58 or about 0.60 to any of about 0.62, about 0.64, about 0.66, about 0.68, about 0.70, about 0.72, about 0.74, about 0.76, about 0.78, about 0.80 or about 0.90. Alternative embodiments can have an average porosity of from any of about 0.45, about 0.47, about 0.49, about 0.51, about 0.53, about 0.55 or about 0.57 to any of about 0.59, about 0.61, about 0.63 or about 0.65.

In further embodiments, the structural colorant photonic spheres have an average pore diameter, e.g., of from any of about 50 nm, about 60 nm, about 70 nm, 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm or about 800 nm. Alternative embodiments can have an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorant photonic spheres can have, e.g., an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm; an average porosity of from any of about 0.45, about 0.47, about 0.49, about 0.51, about 0.53, about 0.55 or about 0.57 to any of about 0.59, about 0.61, about 0.63 or about 0.65; and an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorant photonic spheres can have, e.g., from about 60.0 wt % to about 99.9 wt % metal oxide, based on the total weight of the colorants. In other embodiments, the structural colorants comprise from about 0.1 wt % to about 40.0 wt % of one or more light absorbers, based on the total weight of the colorants. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt % or about 85.0 wt % to any of about 88.0 wt %, about 91.0 wt %, about 94.0 wt %, about 97.0 wt %, about 98.0 wt %, about 99.0 wt % or about 99.9 wt % metal oxide, based on the total weight of the structural colorant photonic spheres.

In certain embodiments, the structural colorant photonic spheres are prepared by a process comprising forming a liquid dispersion of polymer particles and a metal oxide; forming liquid droplets of the dispersion; drying the liquid droplets to provide polymer template particles comprising polymer and metal oxide; and removing the polymer from the template spheres to provide metal oxide particles. In such embodiments, the particles may be porous and/or monodisperse.

In other embodiments, the structural colorant photonic spheres are prepared by a process comprising forming a liquid dispersion of monodisperse polymer particles; forming at least one further liquid solution or dispersion of monodisperse polymer particles; mixing each of the solutions or dispersions together; forming droplets of the mixture; and drying the droplets to provide polymer particles that are polydisperse when the average diameters of the monodisperse polymer particles of each of the dispersions are different. In certain such embodiments, the particles are porous.

In certain embodiments, the structural colorant photonic spheres are prepared by a process comprising forming a dispersion of polymer particles and a metal oxide in a liquid medium; evaporating the liquid medium to obtain polymer-metal oxide particles; and calcining the particles to obtain the structural colorants. In these embodiments, the evaporation of the liquid medium may be performed in the presence of self-assembly substrates such as conical tubes or photolithography slides. In certain such embodiments, the particles are porous.

In certain embodiments, the structural colorants may be recovered, e.g., by filtration or centrifugation.

In certain embodiments, the drying comprises microwave irradiation, oven drying, drying under vacuum, drying in the presence of a desiccant, or a combination thereof.

In certain embodiments with liquid droplets, the droplets are formed with a microfluidic device. The microfluidic device can contain a droplet junction having a channel width, e.g., of from any of about 10 μm, about 15 μm, about 20 μm, about 25 μm, about 30 μm, about 35 μm, about 40 μm or about 45 μm to any of about 50 μm, about 55 μm, about 60 μm, about 65 μm, about 70 μm, about 75 μm, about 80 μm, about 85 μm, about 90 μm, about 95 μm or about 100 μm.

In certain embodiments, the wt/wt ratio of polymer particles to the metal oxide is from about 0.5/1 to about 10.0/1. In other embodiments, the wt/wt ratio is from any of about 0.1/1, about 0.5/1, about 1.0/1, about 1.5/1, about 2.0/1, about 2.5/1 or about 3.0/1 to any of about 3.5/1, about 4.0/1, about 5.0/1, about 5.5/1, about 6.0/1, about 6.5/1, about 7.0/1, about 8.0/1, about 9.0/1 or about 10.0/1.

In certain embodiments, the polymer particles have an average diameter of from about 50 nm to about 990 nm. In other embodiments, the particles have an average diameter of from any of about 50 nm, about 75 nm, about 100 nm, about 130 nm, about 160 nm, about 190 nm, about 210 nm, about 240 nm, about 270 nm, about 300 nm, about 330 nm, about 360 nm, about 390 nm, about 410 nm, about 440 nm, about 470 nm, about 500 nm, about 530 nm, about 560 nm, about 590 nm or about 620 nm to any of about 650 nm, a bout 680 nm, about 710 nm, about 740 nm, about 770 nm, about 800 nm, about 830 nm, about 860 nm, about 890 nm, about 910 nm, about 940 nm, about 970 nm or about 990 nm.

In certain embodiments, the polymer is selected from the group consisting of poly(meth)acrylic acid, poly(meth)acrylates, polystyrenes, polyacrylamides, polyethylene, polypropylene, polylactic acid, polyacrylonitrile, derivatives thereof, salts thereof, copolymers thereof and combinations thereof. The polystyrenes can be, e.g., polystyrene copolymers such as polystyrene/acrylic acid, polystyrene/poly(ethylene glycol) methacrylate or polystyrene/styrene sulfonate.

In certain embodiments, the metal oxide is selected from the group consisting of silica, titania, alumina, zirconia, ceria, iron oxides, zinc oxide, indium oxide, tin oxide, chromium oxide and combinations thereof.

In certain embodiments, removing the polymer spheres from the template microspheres comprises calcination, pyrolysis or solvent removal. The calcining of the template spheres can be, e.g., at temperatures of from about 300° C. to about 800° C. for a period of from about 1 hour to about 8 hours.

In certain embodiments disclosed herein, the structural colorant photonic spheres can be metal oxide particles which may be prepared with the use of a polymeric sacrificial template. In one embodiment, an aqueous colloid dispersion containing polymer particles and a metal oxide is prepared, the polymer particles being, e.g., nano-scaled. The aqueous colloidal dispersion is mixed with a continuous oil phase, for instance within a microfluidic device, to produce a water-in-oil emulsion. Emulsion aqueous droplets are prepared, collected and dried to form particles (e.g., spheres) containing polymer particles (e.g., nanoparticles) and metal oxide. Alternatively, the particles can be prepared by evaporation. The polymer particles or spheres are then removed, for instance via calcination, to provide metal oxide particles or spheres that are, e.g., micron-scaled, and that contain a high degree of porosity with, e.g., nano-scaled pores. The particles may contain uniform pore diameters as a result of the polymer particles being spherical and monodisperse. The removal of the polymer partciles form an “inverse structure” or inverse opal. The particles prior to calcination are considered to be a “direct structure” or direct opal.

The structural colorant photonic spheres in certain embodiments are porous and can be advantageously sintered, resulting in a continuous solid structure which is thermally and mechanically stable.

In some embodiments, droplet formation and collection occurs within a microfluidic device. Microfluidic devices are for instance narrow channel devices having a micron-scaled droplet junction adapted to produce uniform size droplets connected to a collection reservoir. Microfluidic devices for example contain a droplet junction having a channel width of from about 10 μm to about 100 μm. The devices are for instance made of polydimethylsiloxane (PDMS) and may be prepared for example via soft lithography. An emulsion may be prepared within the device via pumping an aqueous dispersed phase and oil continuous phase at specified rates to the device where mixing occurs to provide emulsion droplets. Alternatively, an oil-in-water emulsion may be employed.

Suitable template polymers include thermoplastic polymers. For example, template polymers are selected from the group consisting of poly(meth)acrylic acid, poly(meth)acrylates, polystyrenes, polyacrylamides, polyvinyl alcohol, polyvinyl acetate, polyesters, polyurethanes, polyethylene, polypropylene, polylactic acid, polyacrylonitrile, polyvinyl ethers, derivatives thereof, salts thereof, copolymers thereof and combinations thereof. For example, the polymer is selected from the group consisting of polymethyl methacrylate, polyethyl methacrylate, poly(n-butyl methacrylate), polystyrene, poly(chloro-styrene), poly(alpha-methyl styrene), poly(N-methylolacrylamide), styrene/methyl methacrylate copolymer, polyalkylated acrylate, polyhydroxyl acrylate, polyamino acrylate, polycyanoacrylate, polyfluorinated acrylate, poly(N-methylolacrylamide), polyacrylic acid, polymethacrylic acid, methyl methacrylate/ethyl acrylate/acrylic acid copolymer, styrene/methyl methacrylate/acrylic acid copolymer, polyvinyl acetate, polyvinylpyrrolidone, polyvinylcaprolactone, polyvinylcaprolactam, derivatives thereof, salts thereof, and combinations thereof.

In certain embodiments, polymer templates include polystyrenes, including polystyrene and polystyrene copolymers. Polystyrene copolymers include copolymers with water-soluble monomers, for example polystyrene/acrylic acid, polystyrene/poly(ethylene glycol) methacrylate, and polystyrene/styrene sulfonate.

Present metal oxides include oxides of transition metals, metalloids and rare earths, for example silica, titania, alumina, zirconia, ceria, iron oxides, zinc oxide, indium oxide, tin oxide, chromium oxide, mixed metal oxides, combinations thereof, and the like.

The wt/wt (weight/weight) ratio of polymer nanoparticles to metal oxide is for instance from about 0.1/1 to about 10.0/1 or from about 0.5/1 to about 10.0/1.

The continuous oil phase comprises for example an organic solvent, a silicone oil or a fluorinated oil. According to the invention “oil” means an organic phase immiscible with water. Organic solvents include hydrocarbons, for example, heptane, hexane, toluene, xylene, and the like, as well as alkanols such as methanol, ethanol, propanol, etc.

The emulsion droplets are collected, dried and the polymer is removed. Drying is performed for instance via microwave irradiation, in a thermal oven, under vacuum, in the presence of a desiccant or a combination thereof.

Polymer removal may be performed for example via calcination, pyrolysis or with a solvent (solvent removal). Calcination is performed in some embodiments at temperatures of at least about 200° C., at least about 500° C., at least about 1000° C., from about 200° C. to about 1200° C. or from about 200° C. to about 700° C. The calcining can be for a suitable period, e.g., from about 0.1 hour to about 12 hours or from about 1 hour to about 8.0 hours. In other embodiments, the calcining can be for at least about 0.1 hour, at least about 1 hour, at least about 5 hours or at least about 10 hours. In other embodiments, the calcining can be from any of about 200° C., about 350° C., about 400° C., 450° C., about 500° C. or about 550° C. to any of about 600° C., about 650° C., about 700° C. or about 1200° C. for a period of from any of about 0.1 h (hour), 1 h, about 1.5 h, about 2.0 h, about 2.5 h, about 3.0 h, about 3.5 h or about 4.0 h to any of about 4.5 h, about 5.0 h, about 5.5 h, about 6.0 h, about 6.5 h, about 7.0 h, about 7.5 h about 8.0 h or about 12 h.

Alternatively, a liquid dispersion comprising polymer particles and metal oxide is formed with an oil dispersed phase and a continuous water phase to form an oil-in-water emulsion. The oil droplets may be collected and dried as are aqueous droplets.

The structural colorant photonic spheres may be micron-scaled, for example having average diameters from about 0.5 microns (μm) to about 100 μm. The polymer particles employed as a template may also be spherical and nano-scaled and are monodisperse, having average diameters for instance from about 50 nm to about 999 nm. The polymer particles may also be polydisperse by being a mixture of monodisperse particles. The metal oxide employed may also be in particle form, which particles may be nano-scaled.

The metal oxide of the dispersion may be provided as metal oxide or may be provided from a metal oxide precursor, for instance via a sol-gel technique.

Drying of the polymer/metal oxide particles followed by removal of the polymer provides particles having uniform voids (pores). In general, in the present processes, each droplet provides a single particle. The pore diameters are dependent on the size of the polymer particles. Some compaction may occur upon polymer removal, providing pore sizes somewhat smaller than the original polymer particle size, for example from about 10% to about 40% smaller than the polymer particle size. The pore diameters are uniform as are the polymer particle shape and size.

Pore diameters may range in some embodiments from about 50 nm to about 999 nm.

The average porosity of the present metal oxide particles may be relatively high, for example from about 0.10 or about 0.30 to about 0.80 or about 0.90. Average porosity of a particle means the total pore volume, as a fraction of the volume of the entire particle. Average porosity may be called “volume fraction.”

In some embodiments, porous structural colorant photonic spheres may have a solid core (center) where the porosity is in general towards the exterior surface of the particle (e.g., sphere). In other embodiments, a porous particle may have a hollow core where a major portion of the porosity is towards the interior of the particle (e.g., sphere). In other embodiments, the porosity may be distributed throughout the volume of the particle. In other embodiments, the porosity may exist as a gradient, with higher porosity towards the exterior surface of the particle and lower or no porosity (solid) towards the center; or with lower porosity towards the exterior surface and with higher or complete porosity (hollow) towards the center.

For any porous spherical particle, the average sphere diameter is larger than the average pore diameter, for example, the average sphere diameter is at least about 25 times, at least about 30 times, at least about 35 times, or at least about 40 times larger than the average pore diameter.

In some embodiments, the ratio of average sphere diameter to average pore diameter prior to mixing with the silane coupling agent is for instance from any of about 40/1, about 50/1, about 60/1, about 70/1, about 80/1, about 90/1, about 100/1, about 110/1, about 120/1, about 130/1, about 140/1, about 150/1, about 160/1, about 170/1, about 180/1 or about 190/1 to any of about 200/1, about 210/1, about 220/1, about 230/1, about 240/1, about 250/1, about 260/1, about 270/1, about 280/1, about 290/1, about 300/1, about 310/1, about 320/1, about 330/1, about 340/1 or about 350/1.

Polymer template particles comprising monodisperse polymer particles may provide, when the polymer is removed, metal oxide microspheres having pores that in general have similar pore diameters. In other embodiments, polydisperse polymer particles can be used wherein the average diameters of the particles are different.

Also disclosed are polymer particles comprising more than one population of monodisperse polymer particles, wherein each population of monodisperse polymer particles has different average diameters.

In certain embodiments, the structural colorant photonic spheres comprise mainly metal oxide, that is, they may consist essentially of or consist of metal oxide. Advantageously, a bulk sample of the particles exhibits color observable by the human eye. A light absorber may also be present in the particles, which may provide a more saturated observable color. Absorbers include inorganic and organic pigments, for example a broadband absorber such as carbon black. Absorbers may for instance be added by physically mixing the particles and the absorbers together or by including the absorbers in the droplets to be dried. For carbon black, controlled calcination may be employed to produce carbon black in situ from polymer decomposition. A present particle may exhibit no observable color without added light absorber and exhibit observable color with added light absorber.

The structural colorant photonic spheres utilized in the present invention may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved for example with the use of monodisperse polymer spheres. Angle-dependent color may also be achieved when a step of drying the liquid droplets to provide polymer template spheres is performed slowly, allowing the polymer spheres to become ordered. Angle-independent color may be achieved when a step of drying the liquid droplets is performed quickly, not allowing the polymer spheres to become ordered.

In certain embodiments, the structural colorant photonic spheres may comprise from about 60.0 wt % (weight percent) to about 99.9 wt % metal oxide and from about 0.1 wt % to about 40.0 wt % of one or more light absorbers, based on the total weight of the particles. In other embodiments, the light absorber can be, e.g., from about 0.1 wt % to about 40.0 wt % of one or more light absorbers, for example comprising from any of about 0.1 wt %, about 0.3 wt %, about 0.5 wt %, about 0.7 wt %, about 0.9 wt %, about 1.0 wt %, about 1.5 wt %, about 2.0 wt %, about 2.5 wt %, about 5.0 wt %, about 7.5 wt %, about 10.0 wt %, about 13.0 wt %, about 17.0 wt %, about 20.0 wt % or about 22.0 wt % to any of about 24.0 wt %, about 27.0 wt %, about 29.0 wt %, about 31.0 wt %, about 33.0 wt %, about 35.0 wt %, about 37.0 wt %, about 39.0 wt % or about 40.0 wt % of one or more light absorbers, based on the total weight of the particles.

According to the invention, particle size is synonymous with particle diameter and is determined for instance by scanning electron microscopy (SEM) or transmission electron microscopy (TEM). Average particle size is synonymous with D50, meaning half of the population resides above this point, and half below. Particle size refers to primary particles. Particle size may be measured by laser light scattering techniques, with dispersions or dry powders.

Mercury porosimetry analysis can be used to characterize the porosity of the particles. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. The mercury porosimeter generates volume and pore size distributions from the pressure versus intrusion data generated by the instrument using the Washburn equation. For example, porous silica particles containing voids/pores with an average size of 165 nm have an average porosity of 0.8.

The term “bulk sample” means a population of particles. For example, a bulk sample of particles is simply a bulk population of particles, for instance ≥0.1 mg, ≥0.2 mg, ≥0.3 mg, ≥0.4 mg, ≥0.5 mg, ≥0.7 mg, ≥1.0 mg, ≥2.5 mg, ≥5.0 mg, ≥10.0 mg or ≥25.0 mg. A bulk sample of particles may be substantially free of other components.

The phrase “exhibits color observable by the human eye” means color will be observed by an average person. This may be for any bulk sample distributed over any surface area, for instance a bulk sample distributed over a surface area of from any of about 1 cm², about 2 cm², about 3 cm², about 4 cm², about 5 cm² or about 6 cm² to any of about 7 cm², about 8 cm², about 9 cm², about 10 cm², about 11 cm², about 12 cm², about 13 cm², about 14 cm² or about 15 cm². It may also mean observable by a CIE 1931 2° standard observer and/or by a CIE 1964 10° standard observer. The background for color observation may be any background, for instance a white background, black background or a dark background anywhere between white and black.

The term “of” may mean “comprising”, for instance “a liquid dispersion of” may be interpreted as “a liquid dispersion comprising”.

The terms “microspheres”, “nanospheres”, “droplets”, etc., referred to herein may mean for example a plurality thereof, a collection thereof, a population thereof, a sample thereof or a bulk sample thereof.

The term “micro” or “micro-scaled” means from about 0.5 μm to about 999 μm. The term “nano” or “nano-scaled” means from about 1 nm to about 999 nm.

The term “monodisperse” in reference to a population of particles means particles having generally uniform shapes and generally uniform diameters. A present monodisperse population of particles for instance may have 90%, 91%, 92%, 93%, 94%, 95%, 96%, 97%, 98% or 99% of the particles by number having diameters within ±7%, ±6%, ±5%, ±4%, ±3%, ±2% or ±1% of the average diameter of the population.

Removal of a monodisperse population of polymer particles provides porous metal oxide particles having a corresponding population of pores having an average pore diameter.

The term “substantially free of other components” means for example containing ≤5%, ≤4%, ≤3%, ≤2%, ≤1% or ≤0.5% by weight of other components.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

U.S. patents, U.S. patent applications and published U.S. patent applicants discussed herein are hereby incorporated by reference.

Unless otherwise indicated, all parts and percentages are by weight. Weight percent (wt %), if not otherwise indicated, is based on an entire composition free of any volatiles, that is, based on dry solids content.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Porous Silica Microspheres

A styrene/acrylic acid copolymer is prepared as follows: 230 mL deionized (DI) water is added to a 3-neck reaction flask equipped with a thermometer, condenser, magnetic stirring and nitrogen atmosphere. The water is heated to 80° C. and 10 g of styrene are added with stirring, followed by 100 mg acrylic acid dissolved in 10 mL DI water via syringe. 100 mg of ammonium persulfate is dissolved in 10 mL DI water and added to the stirred mixture via syringe. The reaction mixture is stirred for 24 hours at 80° C. The polymer colloid dispersion is allowed to cool to room temperature and is purified via centrifugation, producing polystyrene nanospheres having an average particle size of 250 nm.

The aqueous polystyrene colloid dispersion is diluted to 1 wt % with deionized water and 1 wt % silica nanoparticles are added and the mixture is sonicated to prevent particle agglomeration. A continuous oil phase contains 0.1 wt % polyethylene glycol/perfluoropolyether surfactant in a fluorinated oil. The aqueous colloid dispersion and oil are each injected into a microfluidic device having a 50 μm droplet junction via syringes associated with pumps. The system is allowed to equilibrate until monodisperse droplets are produced. The monodisperse droplets are collected in a reservoir.

Collected droplets are dried in an oven at 45° C. for 4 hours to provide monodisperse polymer template microspheres. The polymer template microspheres are calcined by placing on a silicon wafer, heating from room temperature to 500° C. over a 3 hour period, holding at 500° C. for 2 hours, and cooling back to room temperature over a 3 hour period. Provided are monodisperse silica microspheres having an average diameter of 15 microns.

### Example 2: Coating Compositions

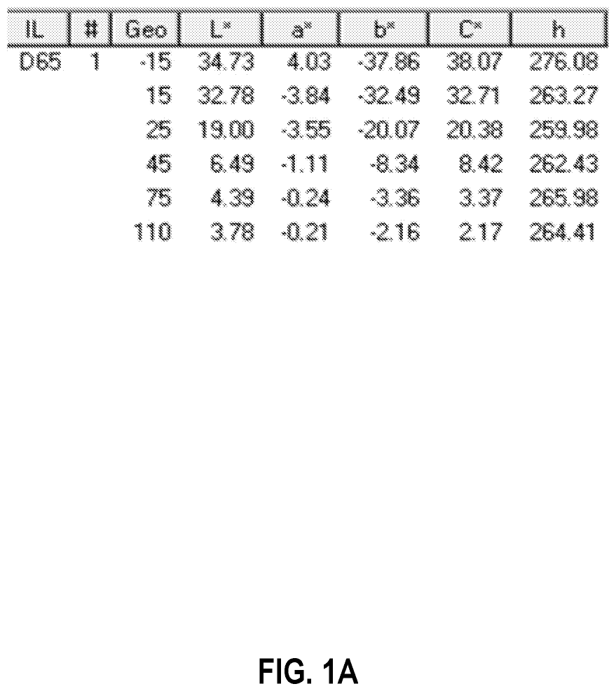

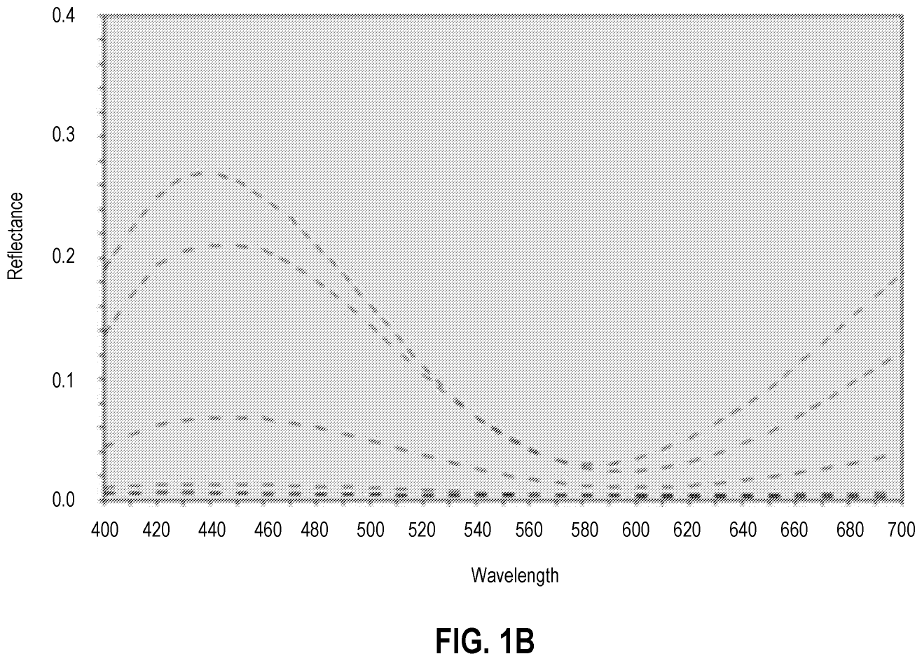

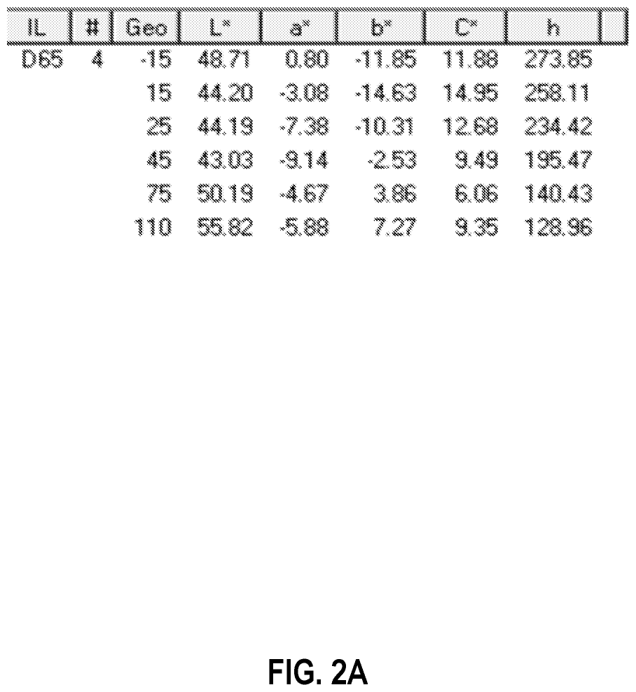

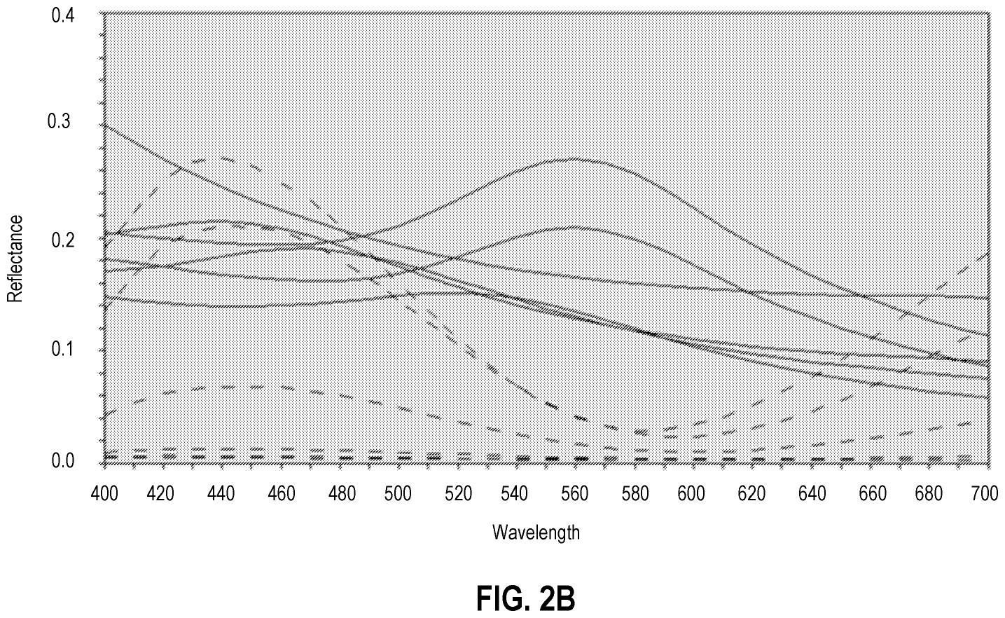

FIGS. 1A, 1B, 2A and 2B contain two data sets, one being the remission curves and the others being the mathematical description of color “space” as calculated in CIEL*a*b* values for photonic spheres of the present invention mixed in a 1:1 ratio with black air dry paint. The latter concerns itself with the L value, a scale of 0 to 100 that describes how light or how dark the color is. The higher the number the more light the color is (e.g., a pure bright white would be 100). The a* value defines how the hue appears on the red-green axis; the more negative the number the greener it is. Similarly, the b* scale defines the yellow-blue color, with a more positive number being more yellow. Color can also be defined using polar coordinates, where the degree of saturation, C*, indicates how vivid the color is. The further away from the origin, the more vivid the color. The hue angle, h, is a representation of the actual hue of the color. Specular reflection (the mirror like reflection) is assigned a value of zero angle. The color is also quantified at 15, 25, 45, 75, and 110 degrees away from the specular reflection. The 15 and 25 degree angles are often referred to as the “face” or “flash” angles, whereas the 75 and 110 degrees are called the “flop” angles.

FIGS. 1A and 1B are directed to typical flake pigment used in the automotive industry. The pigment is titanium dioxide coated mica, where a thin layer of titania is deposited on a translucent uncolored mica flake. The resultant color is a function of a given thickness of titania. The control has a titania thickness that gives a blue color at the near reflection angles, whereas some light transmits through the flake and is colored yellow. The term used for this is a “highlight blue interference mica” because it has a blue color reflecting back to the viewer and it is generated by the light interference coming from the differences in refractive index of the titania and the paint medium, with its coloristic property coming from the selective constructive interference of light waves. The CIEL*a*b* values in FIG. 1A show color that is bright and saturated at the face angle. There are significant differences in b* value from the 15 to the 110 degree angle. The strongly negative numbers indicate a blue color, which sharply becomes less blue at the flop angles. This is also evident for the lightness L* and saturation C* numbers.

FIG. 1B shows the spectral “fingerprint” of the color, showing the percent reflectance of light at the visible wavelengths of light, going from 400 nm to 700 nm. The different dashed lines represent the color at the different viewing angles (decreasing overall intensity with increasing angle). This product shows a strong reflection in the blue region at 15 degrees.

FIGS. 2A and 2B compare the coloristic properties of the photonic microspheres prepared in accordance with the embodiments/examples of the present invention. The reflectance curves (solid lines in FIG. 2B) show a very different characteristic compared to the control, and demonstrate that the L* value do not change significantly and neither does the saturation in the C* column in FIG. 2A. However the hue angle h does change significantly. In this case, there is demonstrated a transition of color hues but the behavior is completely different for this inventive colorant than for the mica as demonstrated in the fingerprint of FIG. 2B.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1-45. (canceled)

46. A coating composition comprising:
a solvent;
a resinous binder; and
a structural colorant comprising photonic spheres.

47. The coating composition of claim 46, wherein the photonic spheres are direct photonic spheres or inverse photonic spheres, wherein the structural colorant exhibits angle-dependent color or angle-independent color, wherein the ratio of structural colorant to resinous binder is about 1:100 to about 50:100.

48. The coating composition of claim 46, wherein the structural colorant comprises a metal oxide selected from the group consisting of silica, titania, alumina, zirconia, ceria, iron oxides, zinc oxide, indium oxide, tin oxide, chromium oxide, and combinations thereof.

49. The coating composition claim 46, wherein the photonic spheres have an average diameter of from about 1 μm to about 75 μm, an average pore diameter of from about 50 nm to about 800 nm, and an average porosity of from about 0.45 to about 0.65.

50. The coating composition of claim 46, wherein at least a portion of external surfaces of the structural colorant comprise silane functional groups.

51. The coating composition of claim 46, wherein the structural colorant comprises transition metal ions.

52. The coating composition of claim 46, wherein the structural colorant comprises carbon black.

53. The coating composition of claim 46, having a Zeta Potential (mV) of from about 5 to about 20, and an intensity of from about 0 to about −100.

54. A coating derived from the coating composition of claim 46.

55. A coating comprising a colorant layer comprising a:
a resinous binder; and
a structural colorant comprising photonic spheres, the coating comprising a ground layer, wherein the colorant layer is layered over the ground layer.

56. The coating of claim 55, further comprising:
a clear coat layer layered over the colorant layer.

57. The coating of claim 56, further comprising:
one or more additional layers (i) between the ground layer and the colorant layer, (ii) between the colorant layer and the clear coat layer, (iii) over the clear coat layer, (iv) under the ground layer, or a combination thereof.

58. The coating of any of claim 56, wherein the coating exhibits:
an L* value from 15 degree angle to 110 degree angle from specular reflection that does not change by more than about 50%,
a C* value from 15 degree angle to 110 degree angle from specular reflection that does not change by more than about 50%, and/or
an h value from 15 degree angle to 110 degree angle from specular reflection that does not change by more than about 75%.

59. The coating of claim 56, wherein the coating exhibits:
an a* value from 15 degree angle to 110 degree angle from specular reflection that does not change by more than about 10 units, and/or
a b* value from 15 degree angle to 110 degree angle from specular reflection that does not change by more than about 25 units.

60. An article of manufacture comprising a substrate and the coating of claim 56, wherein the substrate is an automotive part.

61. A method of preparing a coating composition comprising:
mixing a solvent, a resinous binder, and a structural colorant comprising photonic spheres to obtain the coating composition.

62. The method of claim 61, further comprising:
mixing the solvent and the structural colorant and thereafter adding the resinous binder; and
de-agglomerating the structural colorant.

63. The method of claim 61, further comprising:
selecting dimensions of the structural colorant to achieve a pre-determined color standard, wherein the standard has been previously attained by the structural colorant or achieved by a chemical colorant, and wherein the dimensions are one or more of diameter, pore diameter and porosity.

64. The method of claim 63, wherein the standard color has a wavelength selected from 380-450 nm, 450-485 nm, 485-500 nm, 500-565 nm, 565-590 nm, 590-625 nm, or 625-704 nm.

65. The method of claim 61, wherein the coating is formed on a substrate, and wherein the substrate is an automotive part.
